(19) United States
(12) Patent Application Publication
(10) Pub. No.: US 2020/0139559 A1
(43) Pub. Date: May 7, 2020

(54) ROBOTIC END EFFECTOR ALIGNMENT

(71) Applicant: Park Industries, Inc., St. Cloud, MN (US)

(72) Inventors: Matthew Grow, Otsego, MN (US); Gary K. Morgan, Clear Lake, MN (US); Michael Groetsch, Avon, MN (US)

(21) Appl. No.: 16/179,414

(22) Filed: Nov. 2, 2018

(51) Int. Cl. B25J 15/00; B25J 9/16

(52) U.S. Cl. CPC B25J 15/0019; B25J 9/1692; B25J 15/0066

(57) ABSTRACT

Disclosed herein are systems and methods for aligning an end effector of an industrial robot having a plurality of axes. The end effector can include a bracket, a saw cutting tool, and a water jet cutting tool, wherein the saw cutting tool and the water jet cutting tool are coupled to the bracket. The system for aligning the end effector includes a water jet alignment member removably coupleable to the bracket and the water jet cutting tool and a saw alignment member removably coupleable to the bracket and the saw cutting tool.

### TECHNICAL FIELD

The present invention relates to devices, systems, and methods for aligning an end effector of an industrial robot, and more particularly, aligning a saw blade and water jet end effector.

### BACKGROUND OF THE INVENTION

Industrial robots are conventionally used in many industries to increase manufacturing quality and output. Among the various industries that utilize industrial robots, the granite and related marble industries are using industrial robots at an increasing rate to accommodate more intricate cutting patterns. One use of industrial robots within the granite and related marble industries is for accurately cutting slabs of material for use in residential and commercial table tops and countertops.

Conventionally, industrial robots used for cutting slabs of material use an end effector that is a combination rock-cutting saw blade and water jet cutting head. In such a configuration, the saw blade is used to cut straight sections of stone material at a high rate of speed and the water jet is used to cut curves and corners, but at a slower rate of speed. Generally, a cut pattern is imported from a computer aided drafting program and converted into a set of cutting instructions. From these cutting instructions, the combination rock-cutting saw blade and water jet cutting head cuts a design from a slab of material. In most cases, the cut piece of material includes edges and features that have dimensions that fall within a dimensional tolerance in order for that cut piece of material to meet the requirements of the end user. For example, a cut piece of material may require that an edge for the opening for the sink must have a dimension that meets the designed cut pattern within a certain dimensional tolerance in order for the sink to be placed correctly within the end user's kitchen.

In order for a cut piece of material having tight dimensional tolerances to be cut effectively and efficiently, the end effector of the industrial robot must be properly aligned. Proper alignment can mean that the saw blade and the water jet nozzle of the end effector are located and aligned in real space in accordance to where the saw blade and the water jet nozzle of the end effector are located and aligned in virtual space, according to the robotic controller. In other words, proper alignment means that the end effector is where the robotic controller thinks it is.

In the industry, an industrial robot typically requires at least an initial alignment, or calibration, when it is installed or moved. An industrial robot also needs periodic alignment due to wear and tear misalignment, collision misalignment, and other sources of misalignment. In particular to an industrial robot having an end effector that is a combination rock-cutting saw blade and water jet cutting head, the saw blade and water jet have further alignment requirements such as replacement saw blade alignment.

The most prevalent method of aligning the end effector within the industry is to use laser alignment. Laser alignment involves using a laser alignment emitter/receiver to measure end effector movements and orientation with the help of a computer program. Currently, laser alignment systems are very costly and complex, thus only make economic sense for very large operations with many industrial robots.

### SUMMARY

Embodiments disclosed herein are directed to devices, systems and methods of aligning an end effector that is a combination rock-cutting saw blade and water jet cutting head of an industrial robot. The present invention provides a device, system and method for aligning the combination rock-cutting saw blade and water jet cutting head without the need for a laser alignment system.

The embodiments disclosed herein include a system for aligning an end effector of an industrial robot having a plurality of axes. The system further includes the end effector coupled to a distal end of the industrial robot. The end effector can include a bracket coupled to the distal axis of the industrial robot wherein the bracket further includes a plurality of datum mounting pads. The end effector also includes a water jet cutting tool coupled to a first end of the bracket, and a saw cutting tool coupled to a second end of the bracket. The end effector includes one or more alignment members coupleable to the bracket at the datum mounting pads and configured to align the water jet cutting tool and the saw cutting tool.

In one embodiment, the one or more alignment members is a saw alignment member removably coupleable to the bracket and the saw cutting tool.

In another embodiment, the one or more alignment members is a saw alignment member removably coupleable to the bracket and the saw cutting tool.

In another embodiment, the saw alignment member includes one or more datum mounts and a post aperture.

In yet another embodiment, the datum mounts of saw alignment member are configured to engage with the datum mounting pads of the bracket.

In some embodiments, the datum mounts of saw alignment member are configured to threadably engage with the datum mounting pads of the bracket.

In one embodiment, the water jet alignment member includes an alignment brace and a nozzle centering block, wherein the alignment brace removably couples to the bracket at a first end of the alignment brace and the nozzle centering block removably couples to a second end of the alignment brace and the water jet cutting tool.

In an embodiment, the alignment brace further includes an upper brace member and a lower brace member wherein the upper brace member and lower brace member are disposed at an angle less than 90 degrees to each other.

In one embodiment the alignment brace further includes a centering block track and the nozzle centering block further includes a centering aperture and rails. In this embodiment, the rails of the nozzle centering block slidably engage with the centering block track of the alignment brace and the centering aperture slidably engages with the water jet cutting tool.

In one embodiment, the water jet cutting tool couples to the bracket with a bracket mount and a mounting frame.

In yet another embodiment, a method for aligning an end effector of an industrial robot having a plurality of axes is disclosed. The method for aligning an end effector of an industrial robot having a plurality of axes includes loosening the coupling of a saw cutting tool and a water jet cutting tool to a bracket of the end effector, wherein the end effector is coupled to a distal end of the industrial robot. Further, the method includes coupling a water jet alignment member to the bracket and the water jet cutting tool and coupling a saw alignment member to the bracket and the saw cutting tool. The method also includes tightening the coupling of the saw cutting tool and the water jet cutting tool to the bracket of the end effector and removing the water jet alignment member and the saw alignment member from the end effector.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a side view of an industrial robot with a saw and water jet end effector, according to embodiments.

FIG. 2A is an isometric view of a water jet alignment system, according to embodiments.

FIG. 2B is an isometric view of a saw blade alignment system, according to embodiments.

FIG. 3A is an isometric view of a bracket of an end effector, according to embodiments.

FIG. 3B is a top view of a bracket of an end effector, according to embodiments.

FIG. 3C is a front view of a bracket of an end effector, according to embodiments.

FIG. 4A is an isometric view of a saw and water jet end effector, according to embodiments.

FIG. 4B is an isometric view of a bracket mount of a water jet alignment system, according to embodiments.

FIG. 4C is an isometric view of a mounting frame of a water jet alignment system, according to embodiments.

FIG. 4D is a right side view of a mounting frame of a water jet alignment system, according to embodiments.

FIG. 5 is an isometric view of a saw of an end effector, according to embodiments.

FIG. 6A is an isometric view of an alignment brace of a water jet alignment system, according to embodiments.

FIG. 6B is an isometric view of a saw alignment member for a saw blade alignment system, according to embodiments.

FIG. 7 is an isometric view of a nozzle centering block of a water jet alignment system, according to the embodiments.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments disclosed herein are directed to devices, systems and methods of aligning the saw blade and water jet cutting head of an end effector of an industrial robot. In embodiments, a 6 axis industrial robot is discussed, yet, industrial robots having more or less axes can be used the disclosed embodiments. In embodiments, the industrial robots discussed herein can be operated using a robotic controller. The robotic controller can comprise a programmable central processing unit, a memory, a user interface, and various inputs for communication with other programmable central processing units. In embodiments, the user interface can include a teaching pendant, for example.

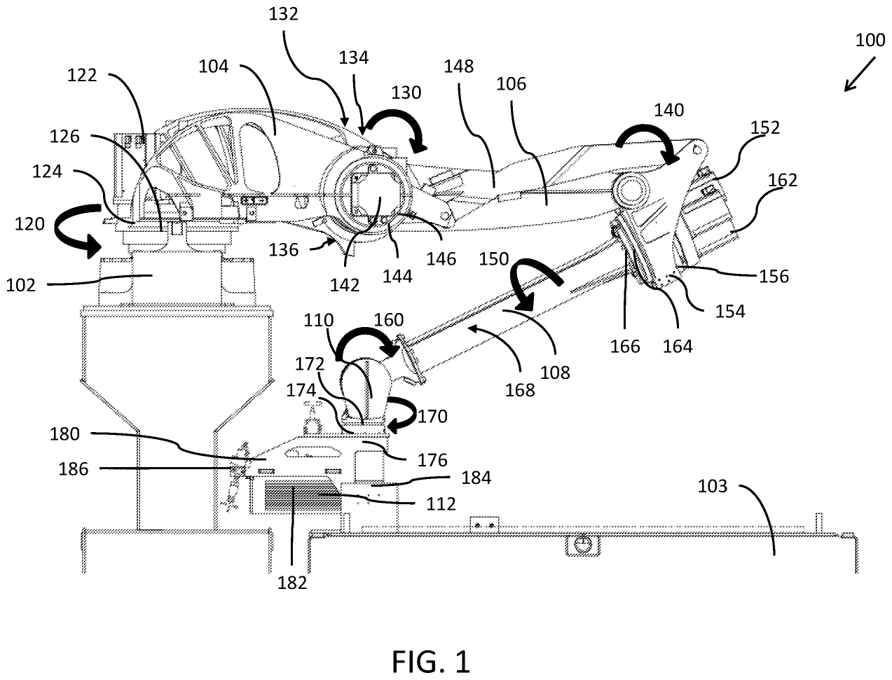

FIG. 1 depicts an embodiment of a 6 axis industrial robot 100 having 6 degrees of freedom. Further, industrial robot 100 is operated using a robotic controller. In this embodiment, industrial robot 100 can include a base 102, a table 103, a first arm 104, a second arm 106, a third arm 108, a fourth arm 110, and an end effector 112.

In embodiments, base 102 can be rotatably coupled to first arm 104 at first axis 120. First axis 120 includes a servomotor 122, reduction gear 124, and position sensor 126. In embodiments, servomotor 122 and reduction gear 124 are configured to rotate first arm 104 with respect to base 102. Further, position sensor 126 is configured to relay axis position information, with high accuracy in some embodiments, to the robotic controller. The robotic controller uses the axis position information sent from position sensor 126 to control motion and speed of motion of first arm 104 at first axis 120.

In embodiments, first arm 104 can be rotatably coupled to second arm 106 at second axis 130. Second axis 130 includes a servomotor 132, reduction gear 134, and position sensor 136. In embodiments, servomotor 132 and reduction gear 134 are configured to rotate second arm 106 with respect to first arm 104. Further, position sensor 136 is configured to relay position information, with high accuracy in some embodiments, to the robotic controller. The robotic controller uses the position information sent from position sensor 136 to control motion and speed of motion of second arm 106 at second axis 130.

In embodiments, second arm 106 can be rotatably coupled to third arm 108 at third axis 140. In this embodiment, third axis 140 is powered by a servomotor 142, reduction gear 144, position sensor 146, and hinged arm 148 arranged adjacent to second axis 130. In embodiments, servomotor 142 and reduction gear 144 are configured to rotate third arm 108 with respect to second arm 106 via hinged arm 148. Further, position sensor 146 is configured to relay position information, with high accuracy in some embodiments, to the robotic controller. The robotic controller uses the position information sent from position sensor 146 to control motion and speed of motion of third arm 108 at third axis 140.

In embodiments, third arm 108 can rotate about its own axis and thus forms fourth axis 150. Fourth axis 150 includes a servomotor 152, reduction gear 154, and position sensor 156. In embodiments, servomotor 152 and reduction gear 154 are configured to rotate third arm 108 about itself. Further, position sensor 156 is configured to relay position information, with high accuracy in some embodiments, to the robotic controller. The robotic controller uses the position information sent from position sensor 156 to control rotation and speed of rotation of third arm 108.

In embodiments, fourth arm 110 can be rotatably coupled to third arm 108 at fifth axis 160. In this embodiment, fifth axis 160 is powered by a servomotor 162, reduction gear 164, position sensor 166, and shaft 168 arranged adjacent to third axis 140. In embodiments, servomotor 162 and reduction gear 164 are configured to rotate fourth arm 110 with respect to third arm 108 via shaft 168. Further, position sensor 166 is configured to relay position information, with high accuracy in some embodiments, to the robotic controller. The robotic controller uses the position information sent from position sensor 166 to control motion and speed of motion of fourth arm 110.

In embodiments, end effector 112 can rotate about fourth arm 110 at sixth axis 170. Sixth axis 170 includes a servomotor 172, reduction gear 174, and position sensor 176. In embodiments, servomotor 172 and reduction gear 174 are configured to end effector 112 about fourth arm 110. Further, position sensor 176 is configured to relay position information, with high accuracy in some embodiments, to the robotic controller. The robotic controller uses the position information sent from position sensor 176 to control rotation and speed of rotation of end effector 112 about fourth arm 110.

Industrial robot 100 is further configured for cutting slabs of material, such as granite or marble. For this use, end effector 112 can include a bracket 180, a saw motor 182, rock-cutting saw 184, and water jet cutting head 186. In embodiments, bracket 180 of end effector 112 is configured to couple to fourth arm 110 at sixth axis 170. Bracket 180 is also configured to water jet cutting head 186 at a first end and support saw motor 182 at a second end, which is opposite the first end. Further, rock-cutting saw 184 couples to an output shaft of saw motor 182.

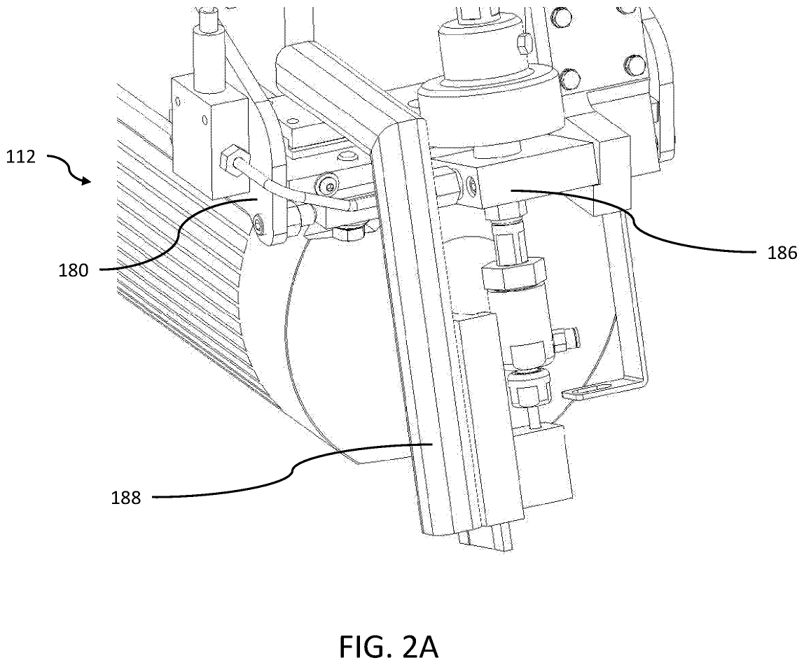

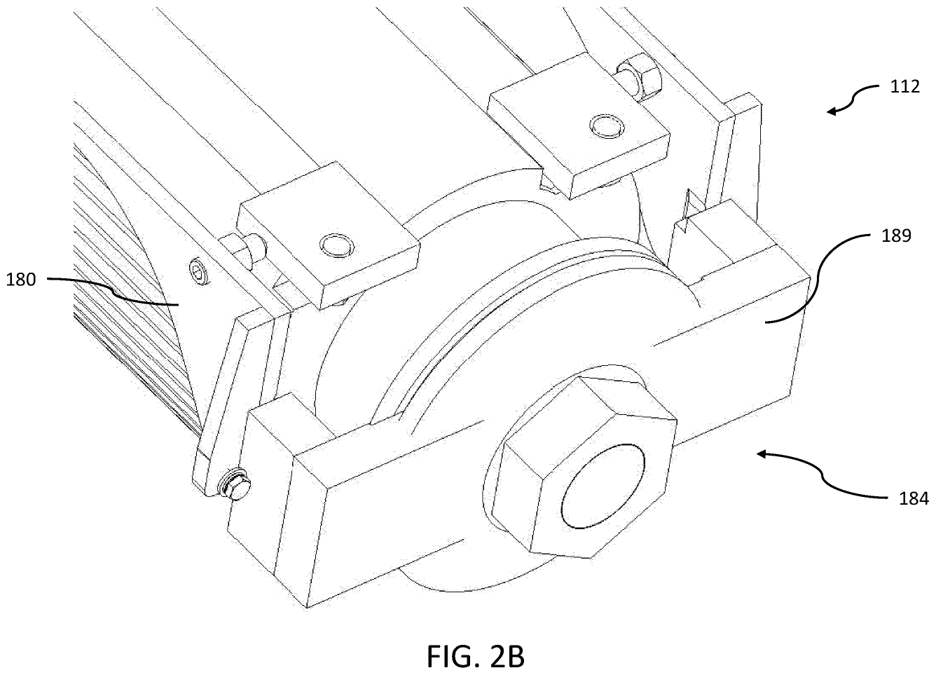

FIGS. 2A and 2B are isometric views of the first and second end of end effector 112, respectively. At the first end of end effector 112 as depicted in FIG. 2A, end effector 112 includes a water jet alignment member 188. Water jet alignment member 188 is configured to selectively couple to both water jet cutting head 186 and bracket 180. When water jet alignment member head 300 is coupled to water jet cutting head 186 and bracket 180, water jet alignment member head 300 aligns water jet cutting head 186 with respect to bracket 180. At the second end of end effector 112 as depicted in FIG. 2B, end effector 112 includes a saw alignment member 189. Saw alignment member 189 is configured to selectively couple to both rock-cutting saw 184 and bracket 180. When saw alignment member head 350 is coupled to rock-cutting saw 184 and bracket 180, saw alignment member head 350 aligns rock-cutting saw 184 with respect to bracket 180.

In some embodiments, the centroid of a saw blade of saw 184, i.e., the radial center of the saw blade and the center of the thickness of the saw blade, fall on the axis of rotation of sixth axis 170. Yet, in other embodiments, the saw blade is offset from sixth axis 170. In this embodiment, water jet cutting head 186 is arranged opposite saw 184. In embodiments, water jet cutting head 186 is configured to deliver a mixture of water and an abrasive, such as garnet, at high enough pressures such that the abrasive mixture forms a cut in the work piece. In embodiments, saw 184 is used to cut straight sections of the work piece at a high rate of speed and water jet cutting head 186 is used to cut curves and corners, but at a slower rate of speed.

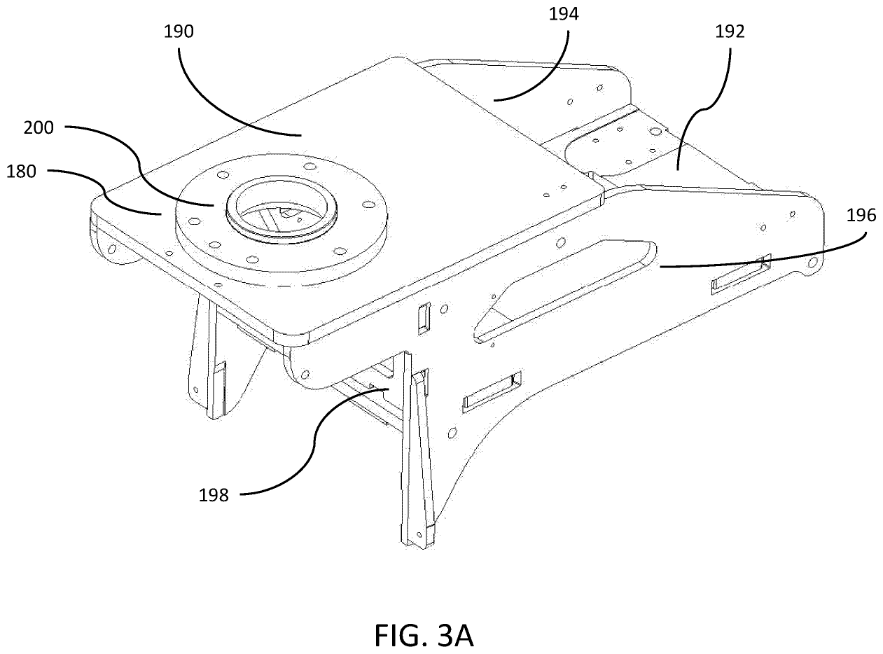

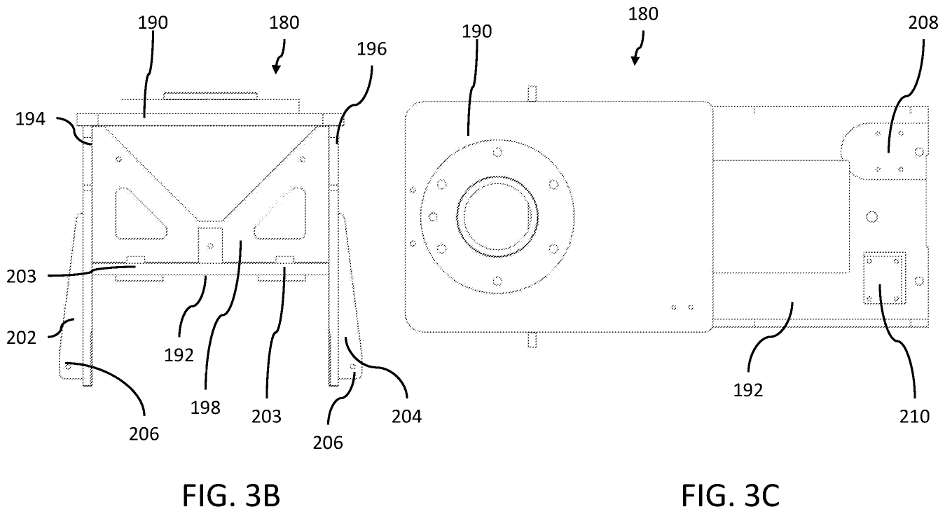

FIGS. 3A-3C depict bracket 180 of end effector 112. Bracket 180 includes a top panel 190, a bottom panel 192, a first side panel 194, a second side panel 196, and a cross support 198.

In embodiments, top panel 190 and bottom panel 192 are arranged parallel to each other each having a first end, a second end, a first side, a second side, a top, and a bottom. The first ends of top panel 190 and bottom panel 192 are located adjacent to saw 184 and the second ends are located opposite the first end. Further, the top and bottom of top panel 190 and bottom panel 192 are dimensionally broad while the first end, second end, first side and second side comprise the width of top panel 190 and bottom panel 192. Both first side panel 194 and second side panel 196 include a first end, a second end, a first side, a second side, a top, and a bottom. The first ends of first side panel 194 and second side panel 196 are located adjacent to saw 184 and the second ends are located opposite the first end. Further, the first side and second side of first side panel 194 and second side panel 196 are dimensionally broad while the first end, second end, top and bottom comprise the width of top panel 190 and bottom panel 192. Cross support 198 includes a first end, a second end, a first side, a second side, a top, and a bottom. Further, the first and second end of cross support 198 dimensionally broad while the first side, second side, top and bottom comprise the width of cross support 198.

In embodiments, top panel 190 is coupled to the second side of first side panel 194 at the first side and bottom panel 192 is coupled to the second side of first side panel 194 at the first side. Further, top panel 190 is coupled to the first side of second side panel 196 at the second side and bottom panel 192 first side of second side panel 196 at the second side. In embodiments, top panel 190 and bottom panel 192 are substantially parallel to each other and substantially perpendicular to first side panel 194 and second side panel 196. In embodiments, the first side of cross support 198 couples to the second side of first side panel 194, the second side of cross support 198 couples to the first side of second side panel 196, the top of cross support 198 is coupled to the bottom of top panel 190, and the bottom of cross support 198 is coupled to the top of bottom panel 192.

In embodiments, top panel 190 includes a collar 200 configured to removably couple bracket 180 to sixth axis 170. In embodiments, collar 200 is arranged on top panel 190 such that the centroid of saw 184 falls on the axis of rotation of sixth axis 170. In alternative embodiments, collar 200 can be arranged at another location on top panel 190. For example, collar 200 can be centrally arranged on top panel 190 such that sixth axis 170 supports end effector 112 with even weight distribution.

FIG. 3B depicts a front view of bracket 180 and depicts the first ends of top panel 190, bottom panel 192, first side panel 194, second side panel 196, and cross support 198. The first end of first side panel 194 includes an arbor datum pad 202. Further, the first end of bottom panel 192 also includes saw mounts 203. The first end of second side panel 196 includes an arbor datum pad 204. Arbor datum pads 202 and 204 can include one or more threaded apertures 206. Arbor datum pads 202 and 204 can have a machined or polished surface, or in alternative embodiments, arbor datum pads 202 and 204 can include a painted or otherwise coated surface. In embodiments, the location of arbor datum pads 202 and 204 and the threaded apertures of arbor datum pads 202 and 204 can have high precision dimensional location with respect to collar 200.

FIG. 3C is a top view of bracket 180 and depicts the top of top panel 190 and the top of bottom panel 192. Bottom panel 192 includes a water jet mount pad 208 and a water jet datum pad 210. Water jet mount pad 208 and water jet datum pad 210 can include a plurality of threaded apertures for fixation. Water jet mount pad 208 and water jet datum pad 210 are arranged on the top of bottom panel 192 adjacent to the second end of bottom panel 192. Water jet mount pad 208 and water jet datum pad 210 can have a precision machined or polished surface, or in alternative embodiments, water jet mount pad 208 and water jet datum pad 210 can include a painted or otherwise coated surface. In embodiments, the location of water jet mount pad 208, water jet datum pad 210, and the threaded apertures of water jet mount pad 208 and water jet datum pad 210 can have high precision dimensional location with respect to collar 200.

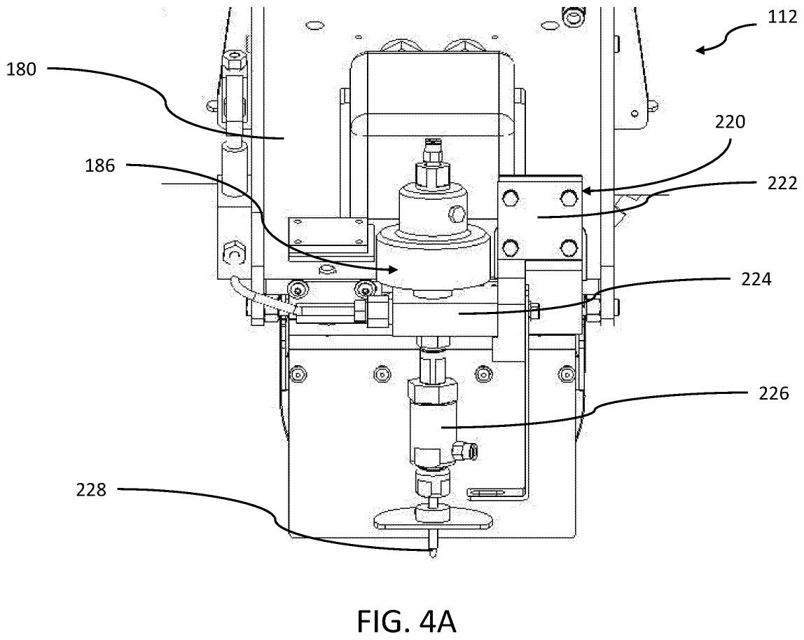

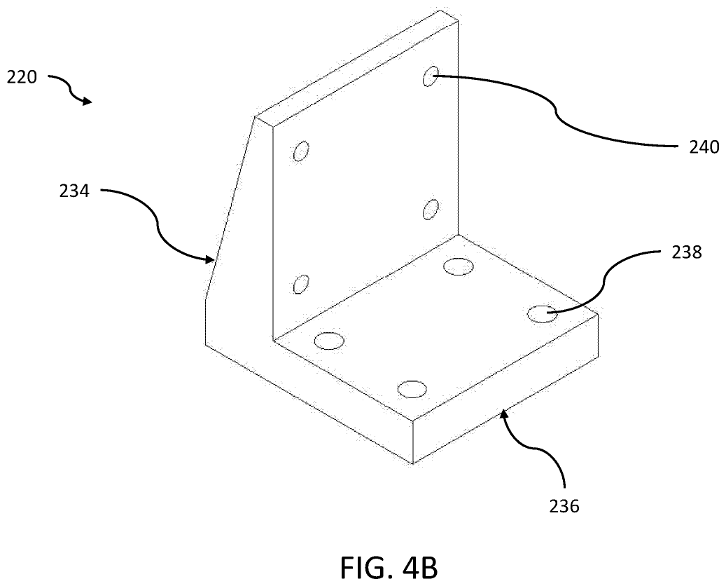

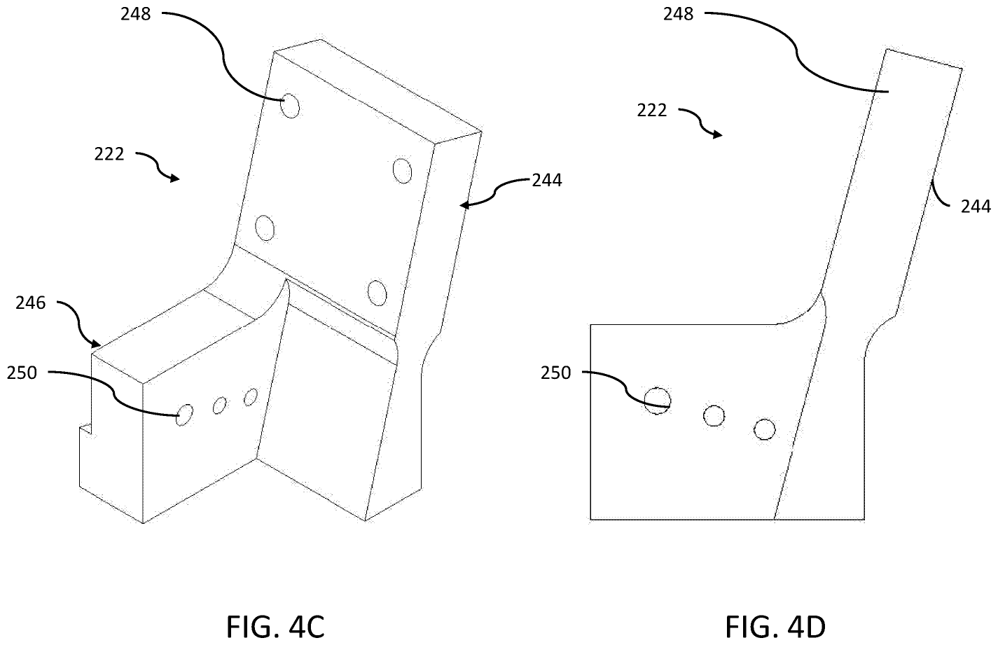

FIG. 4A-4D depicts water jet cutting head 186 of end effector 112. Water jet cutting head 186 can include a bracket mount 220, a mounting frame 222, a manifold 224, a mix chamber 226 and a nozzle 228. As depicted in FIG. 4A, bracket mount 220 is removably coupleable to water jet mount pad 208 of bracket 180. Bracket mount 220 is removably coupleable to bracket 180 using bolts or other suitable removable fasteners. Mounting frame 222 is removably coupleable to Bracket mount 220. Bracket mount 220 is removably coupleable to mounting frame 222 using bolts or other suitable removable fasteners. Manifold 224 is removably coupleable to mounting frame 222. Manifold 224 is removably coupleable to mounting frame 222 using bolts or other suitable removable fasteners. Mix chamber 226 is coupled to manifold 224. Nozzle 228 is coupled to mix chamber 226.

In embodiments, manifold 224 is configured to both support mix chamber 226 and nozzle 228, as well as provide fluid, in the form of high pressure water, to mix chamber 226 and nozzle 228 via internal fluid channel. In embodiments, mix chamber 226 is configured to transfer high pressure water to nozzle 228 as well as provide a mixing aperture for abrasive insertion. At mix chamber 226, the high pressure water is mixed with the abrasive such that an abrasive and high pressure water mixture is sent to nozzle 228. In embodiments, nozzle 228 is configured to collimate and focus the high pressure water and abrasive mixture, such that stream of high pressure water and abrasive capable of cutting stone is delivered to the surface of the work piece at high concentration.

FIG. 4B depicts bracket mount 220 which includes a bracket face 234 and a mount face 236. In embodiments, bracket mount 220 can include a plurality of apertures 238 arranged on bracket face 234. Further, bracket mount 220 can include a plurality of apertures 240 arranged on mount face 236. In embodiments, apertures 238 are configured to provide removable coupling of bracket mount 220 at bracket face 234 to water jet mount pad 208. In embodiments, apertures 240 are configured to provide removable coupling of bracket mount 220 at mount face 236 to mounting frame 222. In embodiments, bracket face 234 and mount face 236 are arranged at an angle to each other, for example 15 degrees.

Referring now to FIGS. 4C-4D, mounting frame 222 can includes a bracket mount face 244 and a manifold face 246. In embodiments, mounting frame 222 can include a plurality of apertures 248 arranged on bracket mount face 244. Further, mounting frame 222 can include a plurality of apertures 250 arranged on manifold face 246. In embodiments, apertures 248 are configured to provide removable coupling of mounting frame 222 at bracket mount face 244 to bracket mount 220. In embodiments, apertures 250 are configured to provide removable coupling of mounting frame 222 at manifold face 246 to manifold 224. In embodiments, bracket mount face 244 and apertures 250 of manifold face 246 are arranged at an angle to each other, for example 15 degrees.

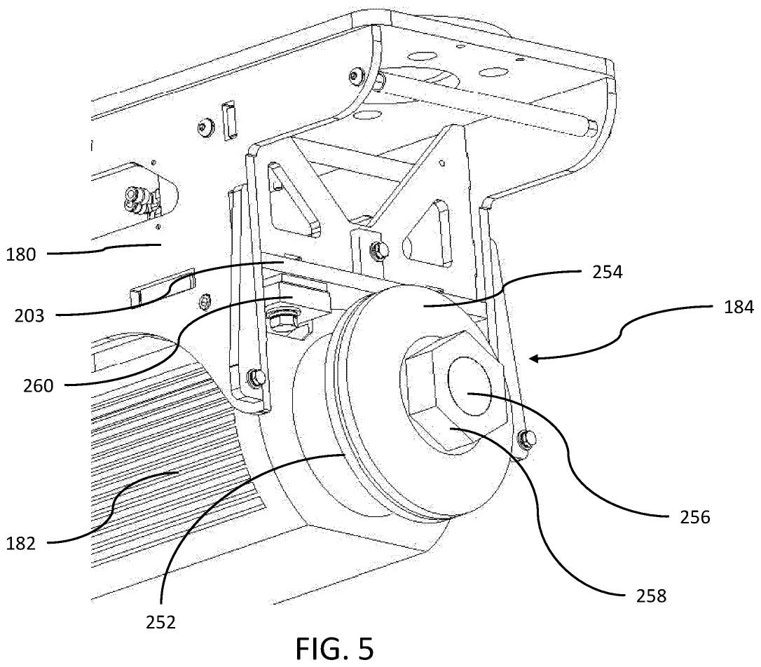

Referring now to FIG. 5, saw motor 182 and saw 184 include an arbor base 252, arbor plate 254, threaded post 256 and lock nut 258. Further, saw motor 182 includes bracket mounts 260. Bracket mounts 260 are configured to removably couple to saw mounts 203 of bracket 180. In embodiments and as previously mentioned, saw motor 182 mounts to bracket 180 such that saw 184 is at an opposite end of water jet cutting head 186. In embodiments, arbor base 252 and threaded post 256 are coupleable to an output shaft of saw motor 182. Further, arbor base 252 and threaded post 256 are configured to provide back and axial support for the saw blade. In embodiments, arbor plate 254 is configured to capture and secure a saw blade against arbor base 252. Further, lock nut 258 and threaded post 256 are configured to removably fix arbor plate 254 against the saw blade such that the saw blade can transfer rotational motion and torque to the cutting periphery of the saw blade.

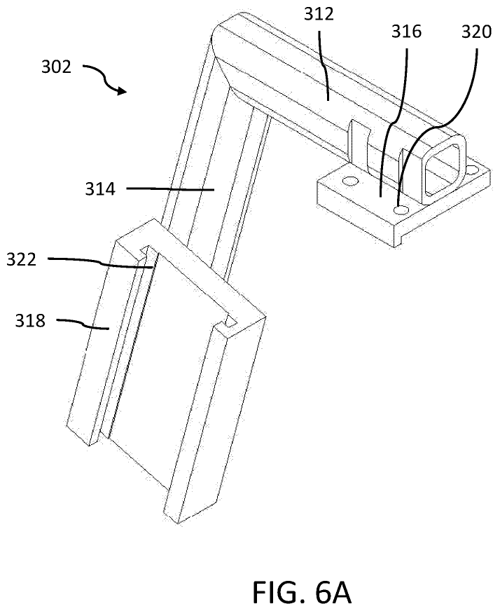

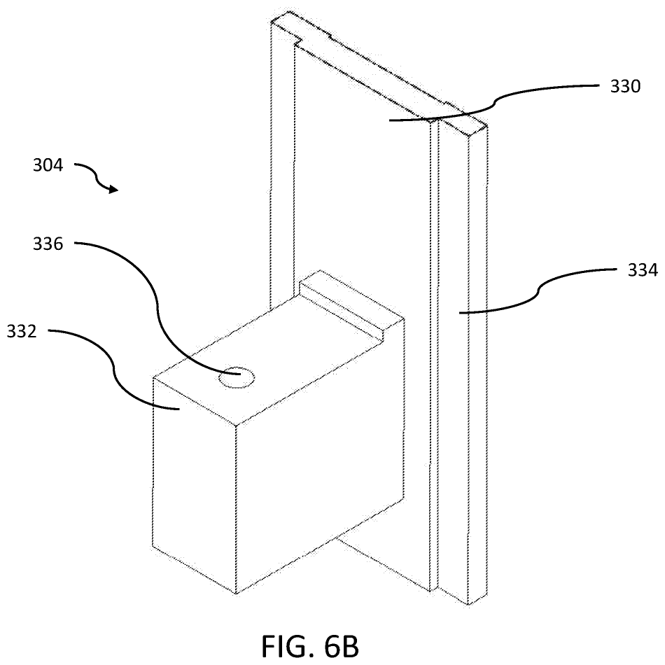

Referring now to FIGS. 6A-6B, end effector 112 includes a water jet alignment member 188. In embodiments, water jet alignment member 188 includes an alignment brace 302 and a nozzle centering block 304. In embodiments, and referring to FIG. 6A, alignment brace 302 includes an upper brace member 312, a lower brace member 314, a datum mount 316, and a centering block track 318. In embodiments, datum mount 316 includes a plurality of apertures 320. Further, centering block track 318 can include a channel 322. Datum mount 316 and apertures 320 are configured to removably couple water jet alignment member 188 to water jet datum pad 210 via threaded bolt or other removable fixation device. In embodiments, datum mount 316 is fixedly coupled to a first end of upper brace member 312. Further, a second end of upper brace member 312 is coupled to a first end of lower brace member 314. In this embodiment, upper brace member 312 is coupled to lower brace member 314 at an angle, e.g., 75 degrees. In embodiments, upper brace member 312 and lower brace member 314 can be fixedly coupled together, or in alternative embodiments, upper brace member 312 and lower brace member 314 can be rotatably coupled together such that various angles of fixation can be attained. In embodiments, centering block track 318 is coupleable to a second end of lower brace member 314.

In embodiments, and referring to FIG. 6B, nozzle centering block 304 include a base 330 and a block 332. Brace 330 further includes rails 334 aligned along outer edges of base 330. Rails 334 are configured to slidably couple with track 318 of alignment brace 302 as depicted in FIG. 6A. In embodiments, block 332 includes a centering aperture 336 arranged within block 332 and aligned in a parallel fashion with rails 334. Centering aperture 336 is configured to slidably receive nozzle 228 as depicted in FIG. 2A.

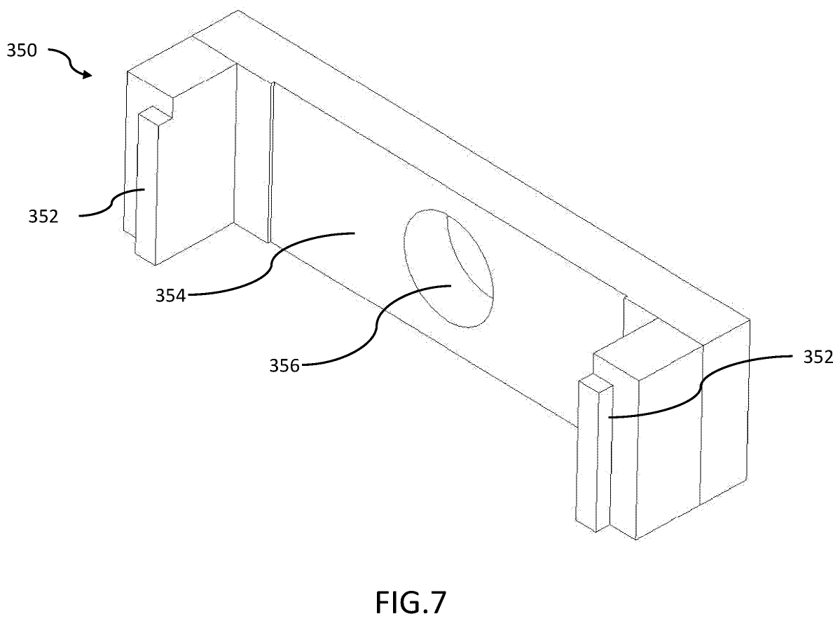

Referring now to FIG. 7, end effector 112 includes a saw alignment member 189. In embodiments, and referring to FIG. 7, saw alignment member head 350 can include saw datum mounts 352, a saw mount face 354, and post aperture 356. In embodiments, saw datum mounts 352 are configured to removably couple to arbor datum pads 202 and 204. In some embodiments, saw datum mounts 352 can include apertures for fixation to threaded apertures 206 of arbor datum pads 202 and 204. In other embodiments, saw datum mounts 352 can be configured to merely rest on the surface of arbor datum pads 202 and 204. In embodiments, post aperture 356 is configured to receive threaded post 256. Further, a saw mount face 354 can include a precision machined surface and can be further configured to facially engage with an outer face of arbor base 252. In embodiments and as depicted in FIG. 2B, saw alignment member 189 is configured to simultaneously receive threaded post 256 at post aperture 356, facially engage with arbor base 252 at saw mount face 354, and facially engage with arbor datum pads 202 and 204 at saw datum mounts 352.

In use, alignment of water jet cutting head 186 and saw 184 with respect to bracket 180 can be accomplished using water jet alignment member 188 and saw alignment member 189. A user can align water jet cutting head 186 and saw 184 in any order. In embodiments, a user can align water jet cutting head 186, as depicted in FIG. 2A, by initially loosening one or more of the following couplings: the coupling between bracket 180 and bracket mount 220, bracket mount 220 and mounting frame 222, and mounting frame 222 and manifold 224. Alignment brace 302 of water jet alignment member 188 can then be fixed to bracket 180 at water jet datum pad 210. Nozzle centering block 304 can then be coupled to alignment brace 302 such that rails 334 of nozzle centering block 304 slide upwardly within track 318 of alignment brace 302. Simultaneously, nozzle 228 of water jet cutting head 186 can be received within centering aperture 336 of nozzle centering block 304. In this configuration, nozzle 228 is properly aligned with respect to bracket 180 of end effector 112, and by extension, industrial robot 100. Once aligned, water jet cutting head 186 can be secured by tightening the previously loosened couplings, i.e., the coupling between bracket 180 and bracket mount 220, bracket mount 220 and mounting frame 222, and/or mounting frame 222 and manifold 224. Prior to use of industrial robot 100, water jet alignment member 188 can be removed via removably sliding nozzle centering block 304 away from nozzle 228, and removing alignment brace 302 from water jet datum pad 210 of bracket 180.

In embodiments, a user can align saw 184, as depicted in FIG. 2B, by loosening bracket mounts 260 of saw motor 182 from saw mounts 203 of bracket 180. In embodiments, other fixation points can be loosened to allow further aligning movement. Further, threaded nut 258 and arbor plate 254 can be removed. Then, saw alignment member 189 can be placed such that saw datum mounts 352 engage with arbor datum pads 202 and 204, post aperture 356 receives threaded post 256, and saw mount face 354 facially engages with arbor base 252. Once saw alignment member 189 is engaged with end effector 112 as previously described, arbor plate 254 and threaded nut 258 can optionally be placed over threaded post 256 to temporarily secure saw alignment member 189 to bracket 180 and saw 184. Alignment can be secured by tightening bracket mounts 260 of saw motor 182 to saw mounts 203 of bracket 180. Prior to use, alignment member 350 can then be removed and a stone cutting saw blade can be secured between arbor base 252 and arbor plate 254.

Because a large portion of alignment needs for an industrial robot used for cutting stone revolve around aligning the tooling of the end effector, utilizing an aligning system that includes a water jet alignment member 188 and a saw alignment member 189 can remove the need for an industrial robot owner to also purchase a laser alignment system. Further, using a water jet alignment member 188 and a saw alignment member 189 to align the tooling of the end effector, a faster and less intrusive alignment can be attained when compared to setting up a laser alignment system.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

1. A system for aligning an end effector of an industrial robot having a plurality of axes:
the end effector coupled to a distal end of the industrial robot and including:
a bracket coupled to the distal axis of the industrial robot, the bracket further including a plurality of datum mounting pads,
a water jet cutting tool coupled to a first end of the bracket, and
a saw cutting tool coupled to a second end of the bracket; and
one or more alignment members coupleable to the bracket at the datum mounting pads and configured to align the water jet cutting tool and the saw cutting tool.

2. The system of claim 1, wherein the one or more alignment members is a saw alignment member removably coupleable to the bracket and the saw cutting tool.

3. The system of claim 1, wherein the one or more alignment members is a saw alignment member removably coupleable to the bracket and the saw cutting tool.

4. The system of claim 3, wherein the saw alignment member includes one or more datum mounts and a post aperture.

5. The system of claim 4, wherein the datum mounts of the saw alignment member are configured to engage with the datum mounting pads of the bracket.

6. The system of claim 5, wherein the datum mounts of the saw alignment member are configured to threadably engage with the datum mounting pads of the bracket.

7. The system of claim 1, wherein the water jet alignment member includes an alignment brace and a nozzle centering block, wherein the alignment brace removably couples to the bracket at a first end of the alignment brace and the nozzle centering block removably couples to a second end of the alignment brace and the water jet cutting tool.

8. The system of claim 7, wherein the alignment brace further includes an upper brace member and a lower brace member wherein the upper brace member and lower brace member are disposed at an angle less than 90 degrees to each other.

9. The system of claim 7, wherein the alignment brace further includes a centering block track and the nozzle centering block further includes a centering aperture and rails, wherein the rails of the nozzle centering block slidably engage with the centering block track of the alignment brace and the centering aperture slidably engages with the water jet cutting tool.

10. The system of claim 1, wherein the water jet cutting tool couples to the bracket with a bracket mount and a mounting frame.

11. A method for aligning an end effector of an industrial robot having a plurality of axes:
loosening the coupling of a saw cutting tool and a water jet cutting tool to a bracket of the end effector, wherein the end effector is coupled to a distal end of the industrial robot and the bracket further includes a plurality of datum mounting pads;
coupling one or more alignment members to the bracket at the datum mounting pads and to the saw cutting tool and the water jet cutting tool;
tightening the coupling of the saw cutting tool and the water jet cutting tool to the bracket of the end effector; and
removing the one or more alignment members from the end effector.

12. The method of claim 11, wherein the one or more alignment members is a saw alignment member removably coupleable to the bracket and the saw cutting tool.

13. The method of claim 11, wherein the one or more alignment members is a saw alignment member removably coupleable to the bracket and the saw cutting tool.

14. The method of claim 13, wherein the saw alignment member includes one or more datum mounts and a post aperture.

15. The method of claim 14, wherein the datum mounts of the saw alignment member are configured to engage with the datum mounting pads of the bracket.

16. The method of claim 15, wherein the datum mounts of the saw alignment member are configured to threadably engage with the datum mounting pads of the bracket.

17. The method of claim 11, wherein the water jet alignment member includes an alignment brace and a nozzle centering block, wherein the alignment brace removably couples to the bracket at a first end of the alignment brace and the nozzle centering block removably couples to a second end of the alignment brace and the water jet cutting tool.

18. The method of claim 17, wherein the alignment brace further includes an upper brace member and a lower brace member wherein the upper brace member and lower brace member are disposed at an angle less than 90 degrees to each other.

19. The method of claim 17, wherein the alignment brace further includes a centering block track and the nozzle centering block further includes a centering aperture and rails, wherein the rails of the nozzle centering block slidably engage with the centering block track of the alignment brace and the centering aperture slidably engages with the water jet cutting tool.

20. The method of claim 11, wherein the water jet cutting tool couples to the bracket with a bracket mount and a mounting frame.
